(19) United States
(12) Patent Application Publication
(10) Pub. No.: US 2021/0055511 A1
(43) Pub. Date: Feb. 25, 2021

(54) LENS MODULE OF REDUCED SIZE AND ELECTRONIC DEVICE HAVING THE SAME

(71) Applicant: TRIPLE WIN TECHNOLOGY(SHENZHEN) CO.LTD., Shenzhen (CN)

(72) Inventors: SHENG-JIE DING, Shenzhen (CN); SHIN-WEN CHEN, Tu-Cheng (TW); JING-WEI LI, Shenzhen (CN); JIAN-CHAO SONG, Shenzhen (CN); SHUAI-PENG LI, Shenzhen (CN)

(21) Appl. No.: 16/568,942

(22) Filed: Sep. 12, 2019

(30) Foreign Application Priority Data
Aug. 22, 2019 (CN) 201910777559.8

(51) Int. Cl. G02B 13/00; G02B 5/26; G02B 7/02

(52) U.S. Cl. CPC G02B 13/001; H04N 5/2254; G02B 7/026; G02B 5/26

(57) ABSTRACT

A robust lens module of reduced size includes an optical filter and a mounting bracket assembly. The mounting bracket assembly includes a first mounting frame and a second mounting frame. The first mounting frame is made of resin and includes side portions defining a receiving space. The second mounting frame includes a black oxidized metal sheet. The second mounting frame is divided into a first connecting ring, a second connecting ring, and a supporting ring. The first connecting ring is fixed on the side portions, the second connecting ring is connected to an inner side of the first connecting ring and protrudes into the receiving space, the supporting ring is connected to a side of the second connecting ring facing away from the first connecting ring. A device utilizing the lens module is also disclosed.

### FIELD

The subject matter relates to imaging devices, and more particularly, to a lens module and an electronic device having the lens module.

### BACKGROUND

Portable electronic devices, such as cell phones, tablet computers, and multimedia players, usually include lens modules. The lens module may comprise a circuit board, an image sensor mounted on the circuit board, a hollow mounting bracket surrounding the image sensor, an optical filter mounted on the mounting bracket and facing the image sensor, and a lens unit positioned above the optical filter. The mounting bracket is made of resin, and can be formed by injection molding.

However, to allow the mounting bracket to have sufficient strength to support the optical filter, the mounting bracket may require a certain thickness, which may increase the size of the lens module. Furthermore, the mounting bracket may have a round edge chamfer at the portion that supports the optical filter, due to the characteristic of the injection molding. The round edge chamfer may reflect a portion of light from the lens unit to the image sensor, which causes stains and anomalies to appear in images and thus lowers the imaging quality.

Therefore, there is room for improvement in the art.

### BRIEF DESCRIPTION OF THE DRAWINGS

Implementations of the present technology will now be described, by way of embodiment, with reference to the attached figures.

FIG. 1 is a diagrammatic view of an embodiment of a lens module.

FIG. 2 is an exploded diagram of the lens module of FIG. 1.

FIG. 3 is a cross-sectional view taken along line of FIG. 1.

FIG. 4 is an enlarged sectional view of the lens module at portion IV of FIG. 3.

FIG. 5 is a diagrammatic view of an embodiment of an electronic device.

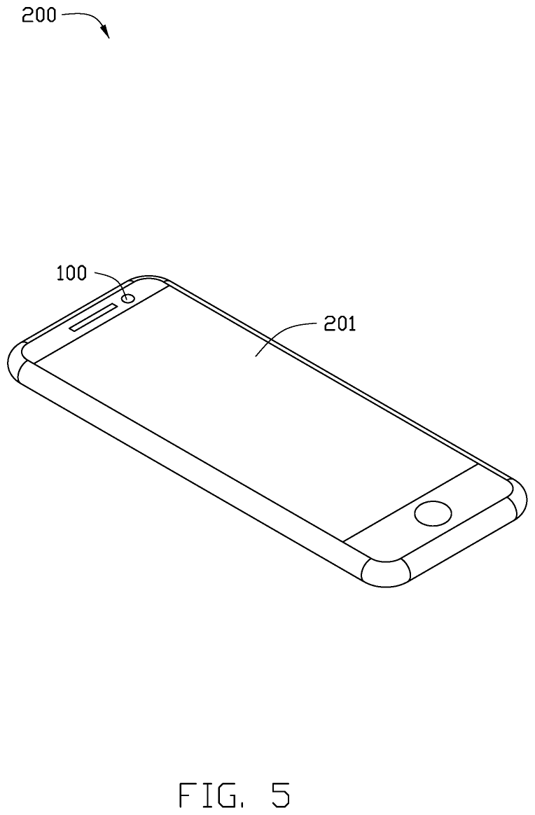

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

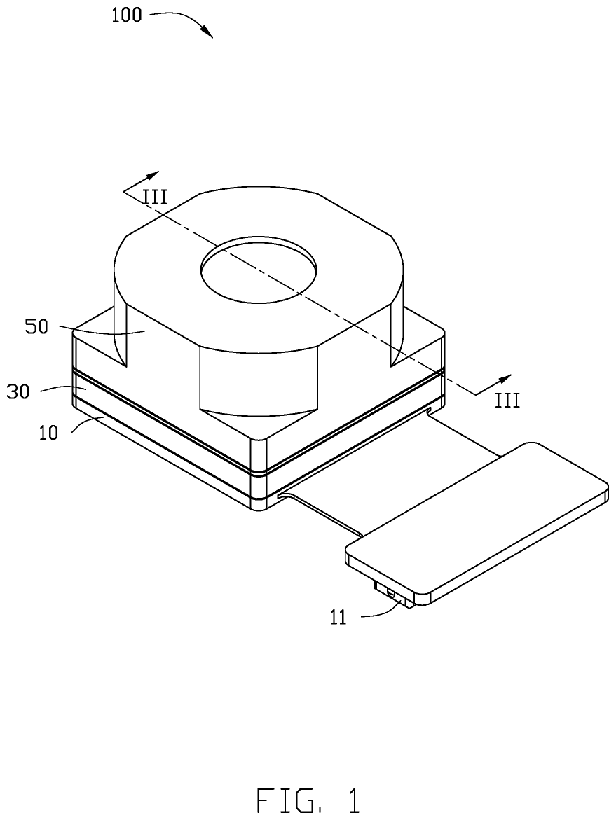

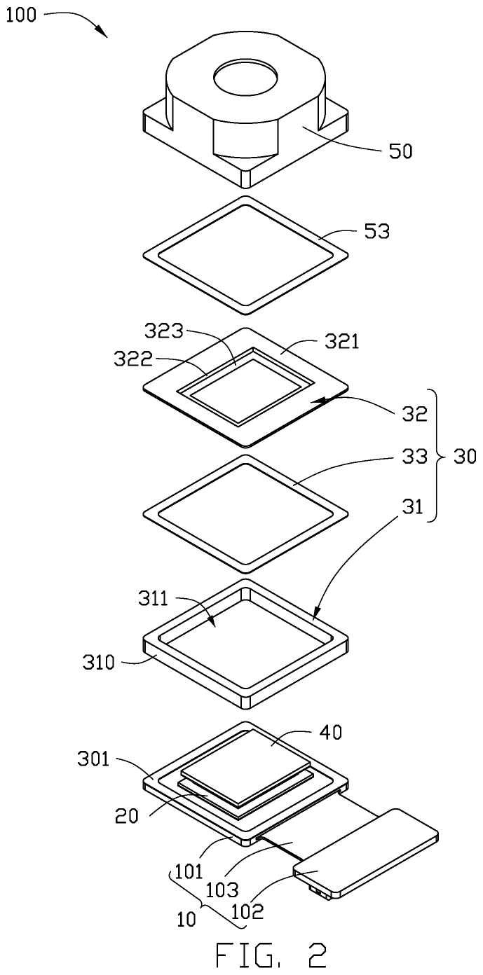

FIGS. 1 to 3 illustrate an embodiment of a lens module 100. The lens module 100 can be used in an electronic device, such as a smart phone, a tablet computer, or a personal digital assistant (PDA). The lens module 100 comprises a circuit board 10, an image sensor 20, a hollow mounting bracket assembly 30, an optical filter 40, and a lens unit 50.

The image sensor 20 is glued to a surface of the circuit board 10 by a first adhesive layer (not shown) disposed in shape of a frame. The first adhesive layer can be made of optically clear adhesive (OCA). The circuit board 10 can be a rigid circuit board, a flexible circuit board, or a rigid-flexible circuit board. In an embodiment, the circuit board 10 is a rigid-flexible circuit board that comprises a first rigid board portion 101, a second rigid board portion 102, and a flexible board portion 103 positioned between the first rigid board portion 101 and the second rigid board portion 102. The image sensor 20 is glued to a surface of the first rigid board portion 101. In an embodiment, the image sensor 20 can be a Complementary Metal Oxide Semiconductor (CMOS) sensor or a Charge Coupled Device (CCD) sensor.

The second rigid board portion 102 can have an electronic connecting member 11 mounted thereon. The electronic connecting member 11 and the image sensor 20 can be at opposite surfaces of the circuit board 10. The electronic connecting member 11 can be gold fingers (edge connector) or other connector.

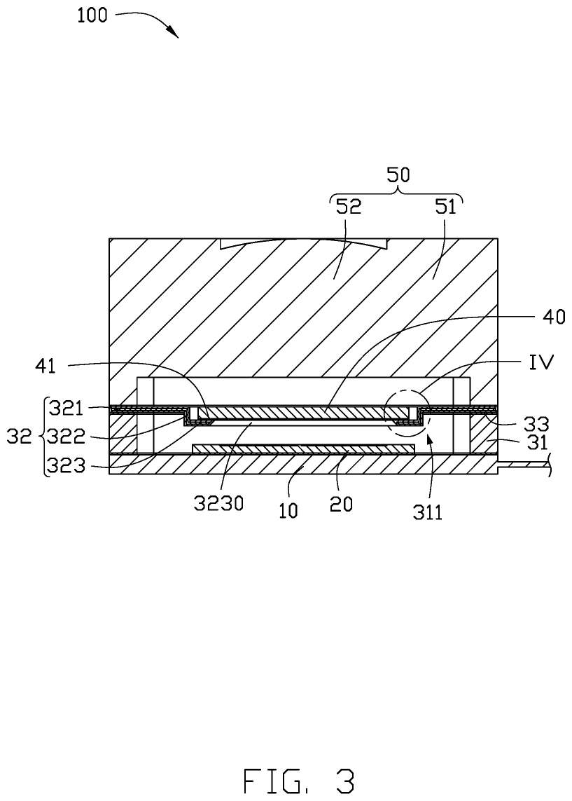

The mounting bracket assembly 30 is glued to the surface of the circuit board 10 (for example, on the first rigid board portion 101) which has the image sensor 20 by a second adhesive layer 301 disposed in shape of a frame. The second adhesive layer 301 can be made of OCA. Referring to FIG. 3, the mounting bracket assembly 30 is substantially square, and includes a first mounting frame 31, a third adhesive layer 33, and a second mounting frame 32 fixed to the first mounting frame 31 through the third adhesive layer 33.

The first mounting frame 31 is made of resin, and formed by injection molding. The first mounting frame 31 is rectangular and substantially hollow, and includes a number of side portions 310 connected end-to-end. The side portions 310 cooperatively define a receiving space 311 of the first mounting frame 31. The image sensor 20 is received in the receiving space 311.

The third adhesive layer 33 is formed on a surface of the side portions 310 facing away from the circuit board 10. The third adhesive layer 33 can be made of OCA.

The second mounting frame 32 includes a hollow metal sheet 3201 formed by punching. A black oxidizing layer 3202 is formed on the metal sheet 3201 by a black anodic oxidation process. The second mounting frame 32 is divided into a first connecting ring 321, a second connecting ring 322, and a supporting ring 323. The first connecting ring 321 is fixed on the third adhesive layer 33. The outer side of the first connecting ring 321 is aligned with the outer side of the first mounting frame 310, and the inner side of the first ring 321 protrudes from the first mounting frame 31 so as to be above the receiving space 311. The second connecting ring 322 is connected to the inner side of the first connecting ring 321. The second connecting ring 322 is perpendicular to the first connecting ring 321, and protrudes into the receiving space 311. The height of the second connecting ring 322 can be substantially equal to the height of the optical filter 40. The supporting ring 323 is connected to a side of the second connecting ring 322 facing away from the first connecting ring 321. The supporting ring 323 has an opening 3230 corresponding to a sensing area (not labeled) of the image sensor 20. The supporting ring 323 can be substantially parallel to the first connecting ring 321.

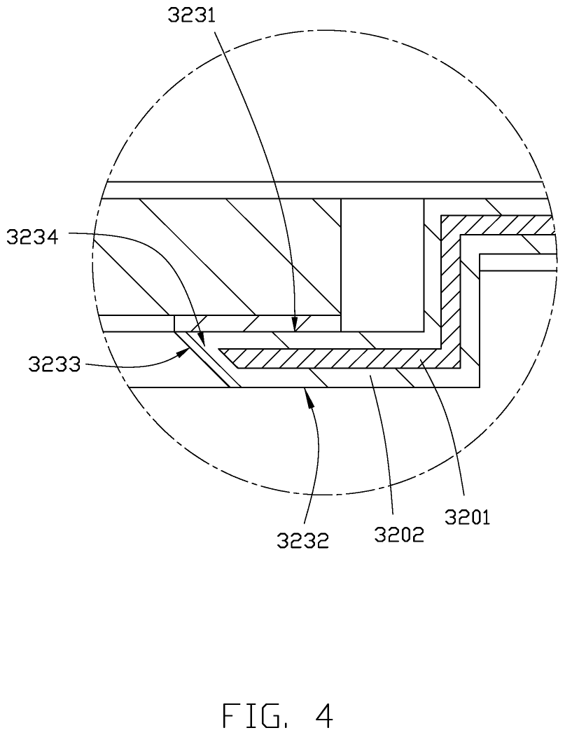

Referring to FIG. 4, the supporting ring 323 includes a first surface 3231 facing the circuit board 10, a second surface 3232 opposite to and parallel to the first surface 3231, and a third surface 3233 between the first surface 3231 and the second surface 3232. The third surface 3233 is inclined towards the first surface 3231, creating included angle 3234 between the first surface 3231 and the third surface 3233. Since the second mounting frame 32 is formed by punching, the included angle 3234 is an acute angle.

The optical filter 40 is glued to the second surface 3232 of the supporting ring 323 by a fourth adhesive layer 41 (see FIG. 3) resembling a frame in shape, and faces the image sensor 20. The surface of the optical filter 40 facing away from the circuit board 10 is substantially flush with the surface of the first connecting ring 321 facing away from the circuit board 10, which reduces the thickness of the lens module 100. The fourth adhesive layer 41 can be made of OCA. The optical filter 40 can be an IR cut-off filter that removes infrared light from incoming light.

The lens unit 50 is glued to the surface of the first connecting ring 321 facing away from the circuit board 10 by a fifth adhesive layer 53. The lens unit 50 comprises a lens holder 51 and a lens 52 received in the lens holder 51. The lens 52 faces the optical filter 40. In an embodiment, the lens 52 is integrally formed with the lens holder 51. The lens holder 51 and the lens 52 can be made of resin.

When in use, the optical filter 40 removes infrared light. The image sensor 20 converts the light which is received to electrical signals, and outputs the electrical signals to the circuit board 10. The circuit board 10 processes the electrical signals to form images. The lens module 100 can be mounted to other components (not shown) of the electronic device through the electronic connecting component 13.

Referring to FIG. 4, the present disclosure further provides an electronic device 200 including a casing 201 and the lens module 100 mounted to the casing 201.

Since the second mounting frame 32 is made of metal, the thickness of the supporting ring 323 can be reduced while retaining the same supporting strength, which can further reduce the size of the electronic device 200. Furthermore, the second mounting frame 32 has the black oxidizing layer which can block light that would otherwise be received by the image sensor 20. Thus, flares or other defects in the image can be prevented. Moreover, the inner side of the supporting ring 323 can form the acute angle since the supporting ring 323 is formed by punching, thereby preventing the supporting ring 323 from reflecting the light towards the image sensor 20. The image quality of the lens module 100 can be improved.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A lens module comprising:
an optical filter; and
a mounting bracket assembly, the optical filter mounted on the mounting bracket assembly, the mounting bracket assembly comprising:
a first mounting frame made of resin and comprising a plurality of side portions connected end-to-end, the plurality of side portions cooperatively defining a receiving space; and
a second mounting frame comprising a metal sheet and a black oxidizing layer formed on the metal sheet, the second mounting frame being divided into a first connecting ring, a second connecting ring, and a supporting ring, the first connecting ring fixed on the plurality of side portions, the second connecting ring connected to an inner side of the first connecting ring and protruding into the receiving space, the supporting ring connected to a side of the second connecting ring facing away from the first connecting ring, the optical filter fixed on the supporting ring.

2. The lens module of claim 1, wherein the supporting ring comprises a first surface, a second surface opposite to and parallel to the first surface, and a third surface connected between the first surface and the second surface, the optical filter is fixed on the second surface, the third surface is inclined towards the first surface to cause the first surface and the third surface to form an included angle, the included angle is an acute angle.

3. The lens module of claim 1, wherein an outer side of the first connecting ring is aligned with an outer side of the first mounting frame, and an inner side of the first ring protrudes from the first mounting frame to be above the receiving space.

4. The lens module of claim 1, wherein the second connecting ring is perpendicular to the first connecting ring and protrudes into the receiving space.

5. The lens module of claim 1, wherein a surface of the optical filter facing away from the second surface is flush with a surface of the first connecting ring facing away from the first mounting frame.

6. The lens module of claim 1, wherein the supporting ring is parallel to the first connecting ring.

7. The lens module of claim 1, wherein the mounting bracket assembly further comprises a third adhesive layer, and the second mounting frame is fixed to the first mounting frame through the third adhesive layer.

8. The lens module of claim 1, further comprising a circuit board and an image sensor mounted on the circuit board, and the image sensor facing the optical filter.

9. The lens module of claim 8, wherein the supporting ring comprises an opening corresponding to a sensing area of the image sensor.

10. An electronic device comprising:
a casing; and
a lens module mounted to the casing, the lens module comprising:
an optical filter; and
a mounting bracket assembly, the optical filter mounted on the mounting bracket assembly, the mounting bracket assembly comprising:
a first mounting frame made of resin and comprising a plurality of side portions connected end-to-end, the plurality of side portions cooperatively defining a receiving space; and
a second mounting frame comprising a metal sheet and a black oxidizing layer formed on the metal sheet, the second mounting frame being divided into a first connecting ring, a second connecting ring, and a supporting ring, the first connecting ring fixed on the plurality of side portions, the second connecting ring connected to an inner side of the first connecting ring and inserting into the receiving space, the supporting ring connected to a side of the second connecting ring facing away from the first connecting ring, the optical filter fixed on the supporting ring.

11. The electronic device of claim 10, wherein the supporting ring comprises a first surface, a second surface opposite to and parallel to the first surface, and a third surface connected between the first surface and the second surface, the optical filter is fixed on the second surface, the third surface is inclined towards the first surface to cause the first surface and the third surface to form an included angle, the included angle is an acute angle.

12. The electronic device of claim 10, wherein an outer side of the first connecting ring is aligned with an outer side of the first mounting frame, and an inner side of the first ring protrudes from the first mounting frame to be above the receiving space.

13. The electronic device of claim 10, wherein the second connecting ring is perpendicular to the first connecting ring and inserts into the receiving space.

14. The electronic device of claim 10, wherein a surface of the optical filter facing away from the second surface is flush with a surface of the first connecting ring facing away from the first mounting frame.

15. The electronic device of claim 10, wherein the supporting ring is parallel to the first connecting ring.

16. The electronic device of claim 10, wherein the mounting bracket assembly further comprises a third adhesive layer, and the second mounting frame is fixed to the first mounting frame through the third adhesive layer.

17. The electronic device of claim 10, wherein the lens module comprises a circuit board and an image sensor mounted on the circuit board, and the image sensor facing the optical filter.

18. The electronic device of claim 17, wherein the supporting ring comprises an opening corresponding to a sensing area of the image sensor.
